(19) United States
(12) Patent Application Publication
(10) Pub. No.: US 2008/0076098 A1
(43) Pub. Date: Mar. 27, 2008

(54) Curriculum-Based Life Skill Education for Soft Contained Play Centers

(76) Inventor: Samuel B. Kellett, Atlanta, GA (US)

Correspondence Address: Kangaroo Bob's, LLC, c/o Biggers & Ohanlan, LLP, P.O. Box 1469, Austin, TX, 78767-1469, US

(21) Appl. No.: 11/533,996

(22) Filed: Sep. 21, 2006

(51) Int. Cl. G09B 19/00

(52) U.S. Cl. 434/236

(57) ABSTRACT

Methods for curriculum-based life skill education for soft contained play centers. Embodiments include providing a curriculum defining a plurality of predefined aspects of a life skill and having an associated set of athletic games, wherein success in playing each athletic game is predetermined to be linked to exhibiting one or more aspects of the particular life skill defined by the curriculum; observing a child play the associated set of athletic games in a soft contained play center; and providing a completion award for exhibiting all the aspects of the particular life skill defined by the curriculum while playing the set of athletic games associated with the curriculum.

### BACKGROUND OF THE INVENTION

1. Field of the Invention

The field of the invention is life skill education for soft contained play centers.

2. Description of Related Art

Children enjoy playing on inflatable play areas often found in recreational centers. Such recreational centers often provide for a fee unstructured play for children. While the children may enjoy playing on the inflatable play centers, their caregivers see this activity only as play and not as education. There is therefore an ongoing need for improvement in the area of conventional recreation centers.

### SUMMARY OF THE INVENTION

Method for curriculum-based life skill education for soft contained play centers. Embodiments include providing a curriculum defining a plurality of predefined aspects of a life skill and having an associated set of athletic games, wherein success in playing each athletic game is predetermined to be linked to exhibiting one or more aspects of the particular life skill defined by the curriculum; observing a child play the associated set of athletic games in a soft contained play center; and providing a completion award for exhibiting all the aspects of the particular life skill defined by the curriculum while playing the set of athletic games associated with the curriculum.

A life skill curriculum for soft contained play centers. Embodiments include an identified life skill defining the subject of the curriculum; an identified plurality of aspects of the life skill defined by the curriculum; and a plurality of games designed to be played in a soft contained play center, wherein success in playing each athletic game is predetermined to be linked to exhibiting one or more predefined aspects of the particular life skill, and wherein the plurality of games together are predetermined to be linked to exhibiting all of the aspects of the life skill.

A soft contained play center. Embodiments include one or more inflatable play areas; and an award redemption facility; and the soft contained play center configured for curriculum-based life skill education including: providing a curriculum defining a plurality of predefined aspects of a life skill and having an associated set of athletic games, wherein success in playing each athletic game is predetermined to be linked to exhibiting one or more aspects of the particular life skill defined by the curriculum; observing a child play the associated set of athletic games in a soft contained play center; and providing a completion award for exhibiting all the aspects of the particular life skill defined by the curriculum while playing the set of athletic games associated with the curriculum.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a soft contained play center according to the present invention.

FIG. 2 sets forth a flow chart illustrating an exemplary method for curriculum-based life skill education for soft contained play centers

FIG. 3 sets forth a block diagram illustrating a specific example of an athletic game useful in for curriculum-based life skill education for soft contained play centers according to the present invention.

FIG. 4 sets forth a block diagram of five themed athletic games that together teach each aspect of a teamwork life skill curriculum

FIG. 5 sets forth a flow chart illustrating an exemplary method of observing a child play a series of athletic games in a soft contained play center.

### DETAILED DESCRIPTION OF EXEMPLARY EMBODIMENTS

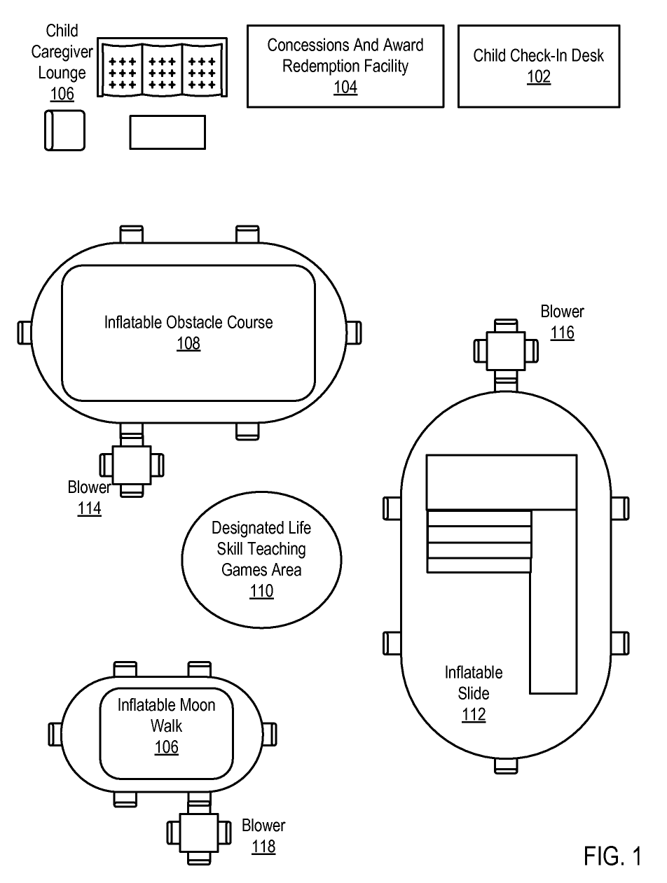

Exemplary methods, curriculums, and soft contained play centers are provided for curriculum-based life skill education for soft contained play centers according to the present invention. FIG. 1 sets forth a block diagram of a soft contained play center according to the present invention. A soft contained play center is a recreational area for children containing one or more inflatable play areas. Soft contained play centers according to the present invention include both indoor recreational areas having inflatable play areas and outdoor recreational areas having inflatable play areas. The exemplary soft contained play center of FIG. 1 is configured for curriculum-based life skill education according to the present invention.

The soft contained play of FIG. 1 includes a plurality of inflatable play areas (106, 108. and 112). Inflatable play areas are inflated structures typically made of vinyl, typically inflated with air by one or more blowers, and often designed according to a theme. The inflatable play areas of FIG. 1 includes an inflatable obstacle course (108) inflated by blower (114), an inflatable slide (112) inflated by blower (116), and an inflatable moon walk (106) inflated by blower (118).

The inflatable obstacle course (108), inflatable slide (112), and inflatable moonwalk (106) are presented for explanation and not for limitation. In fact, soft contained play centers may include any number of different kinds inflatable play areas such as inflatable boxing rings, castles, sport cages, basketball courts, gladiator coliseums, mountains, mazes, bouncers, and many others as will occur to those of skill in the art.

The soft contained play center of FIG. 1 includes a designated games area (110). The designated games area (110) is a predetermined portion of the soft contained play center configured for curriculum-based life skill education for soft contained play centers according to the present invention. A life skill is a trait of adults identified as beneficial to the success or well being of the adult. Examples of such life skills include teamwork, manners, self confidence, honesty, trustworthiness, and many others as will occur to those of skill in the art. Many such targeted life skills may be taught in a soft contained play center according to curriculum-based life skill education according to the present invention.

A life skill has one or more related aspects. Aspects of a life skill are specific characteristics of that life skill. For example, some aspects of the life skill of teamwork include hard work, closeness, leadership, reliability, working together, enthusiasm, emotional control, awareness, no fear of failure, determination, talent, training, team spirit, preparedness, principled, being the best that one can, as well as others as will occur to those of skill in the art.

A curriculum according to the present invention for teaching a particular life skill defines particular aspects of the targeted life skill. For example, a life skill curriculum designed for education of the life skill ‘teamwork’ may define the aspects of hard work, working together, leadership, reliability, closeness, enthusiasm, emotional control, awareness, no fear of failure, determination, talent, train the brain, team spirit, preparedness, and being yourself.

The soft contained play center of FIG. 1 is configured for curriculum-based life skill education by providing a curriculum defining a plurality of predefined aspects of a life skill and having an associated set of athletic games designed to be played in a soft contained play center either in a designated games area (110) or on one or more inflatable play areas (106, 108, 112). Success in playing each athletic game of the set of athletic games is predetermined to be linked to exhibiting one or more aspects of the particular life skill defined by the curriculum (206);

The soft contained play center of FIG. 1 is also configured for curriculum-based life skill education by observing a child play the associated set of athletic games in a soft contained play center and providing a completion award for exhibiting all the aspects of the particular life skill defined by the curriculum while playing the set of athletic games associated with the curriculum. The soft contained play center of FIG. 1 therefore also includes a concessions and award redemption facility (104). Concessions and award redemption facility (104) includes concessions for sale and prizes to be redeemed by children having exhibited aspects of the life skills taught in the soft contained play center. Awards such as completion awards provided for demonstrating all of the aspects defined by a curriculum according to the present invention may be prizes that may be redeemed from redeemable completion awards. Other completion awards may be implemented as diplomas, photographs with graduation attire, and others as will occur to those of skill in the art.

The soft contained play center of FIG. 1 also includes a child caregiver lounge (106). A child caregiver lounge (106) is an area designed for caregivers of children to wait, work, or relax while instructors of the soft contained play center administer structured and unstructured play of the children including curriculum-based life skill education for soft contained play centers.

The soft contained play center of FIG. 1 also includes a child check-in desk (102). The child check-in desk (102) is typically located near the entrance of the soft contained play center and is used to accept entrance of the child in the soft contained play center. In some soft contained play centers according to the present invention, each child is tagged with a Radio Frequency Identification (‘RFID’) tag that sets off an alarm if the child leaves the soft contained play center while wearing the RFID tag.

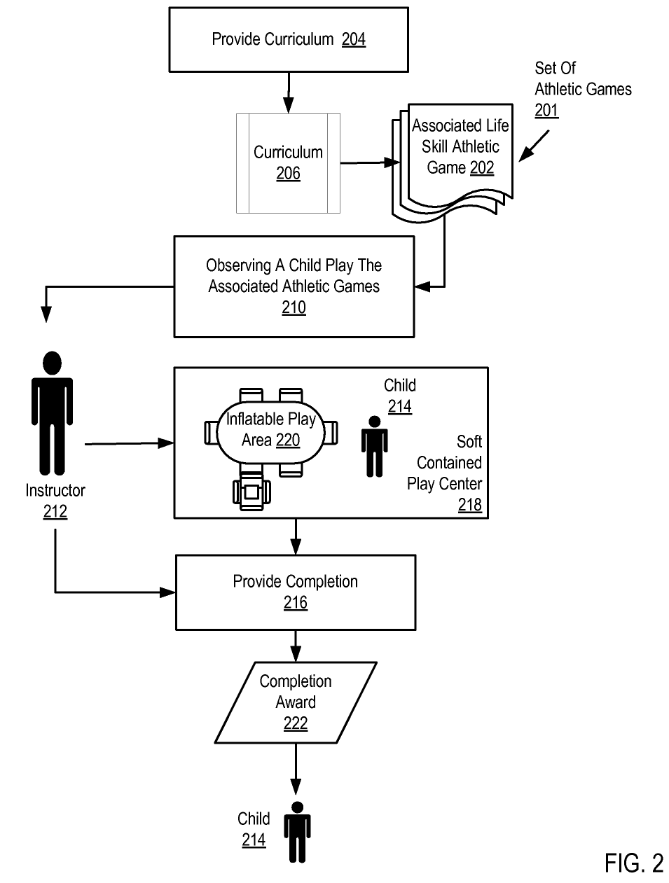

For further explanation, FIG. 2 sets forth a flow chart illustrating an exemplary method for curriculum-based life skill education for soft contained play centers. The method of FIG. 2 includes providing (204) a curriculum (206) defining a plurality of predefined aspects of a life skill and having an associated set (201) of athletic games (202). As mentioned above, success in playing each athletic game (202) is predetermined to be linked to exhibiting one or more aspects of the particular life skill defined by the curriculum (206).

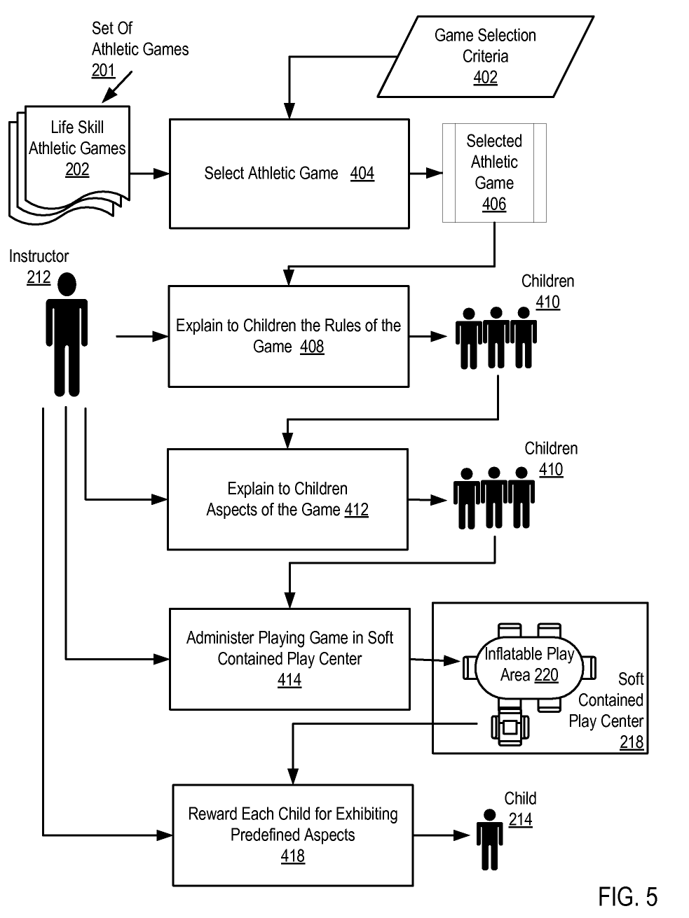

The method of FIG. 2 also includes observing (210) a child (214) play the associated set (201) of athletic games (202) in a soft contained play center (218). Observing (210) a child (214) play the associated set (201) of athletic games (202) in a soft contained play center (218) according to the method of FIG. 2 may be carried out by selecting one of the associated set of athletic games; explaining to one or more children the rules of the selected athletic game; explaining to the one or more children the one or more predefined aspects of the life skill linked to success in playing the selected athletic game; and administering the playing of the selected athletic game by the one or more children in the soft contained play center as discussed below with reference to FIG. 5.

The set (201) of athletic games (202) associated with the curriculum (206) often include a plurality of themed games having one or more components of the theme, each component of the theme based upon one or more of predefined aspects of the life skill defined by the curriculum (206). The set (201) of athletic games (202) associated with the curriculum (206) are also designed to be played on one ore more inflatable play areas (220) in the soft contained play center (218) or in one or more designated areas outside the inflatable play areas in the soft contained play center.

The method of FIG. 2 also includes providing (216) a completion award (222) for exhibiting all the aspects of the particular life skill defined by the curriculum (206) while playing the set (201) of athletic games (202) associated with the curriculum (206). A completion award (222) may be implemented as a redeemable award, such as one or more tickets, for redemption for prizes at an award redemption facility in the soft contained play center. A completion award may also be implemented as a diploma, a photograph such as in graduation attire, or any other completion award that will occur to those of skill in the art. Completion awards advantageously provide incentive to children to demonstrate each and every aspect of the life skill defined by the curriculum.

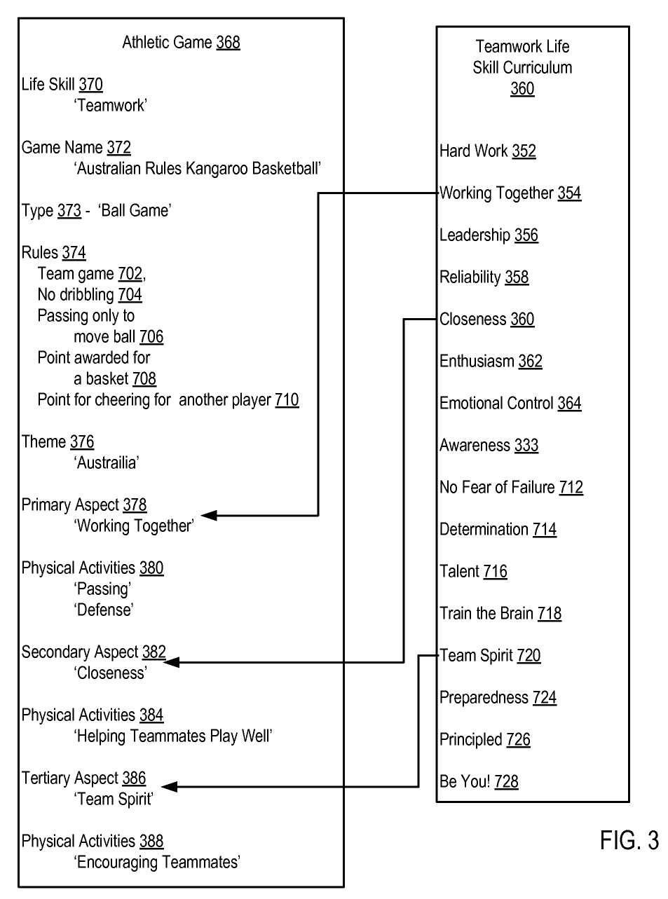

As discussed above, often athletic games associated with curriculums according to the present invention are themed athletic games targeted at a particular life skill taught through the curriculum. For further explanation, therefore, FIG. 3 sets forth a block diagram illustrating a specific example of an athletic game useful in for curriculum-based life skill education for soft contained play centers according to the present invention and a curriculum according to the present invention. In the example of FIG. 3, the athletic game (368) is associated with the life skill curriculum (360) for teaching the life skill ‘Teamwork’ (370) and has a game name (372) of ‘Australian Rules Kangaroo Basketball.’

The exemplary athletic game (368) of FIG. 3 includes rules (374) designed such that success in playing Australian Rules Kangaroo Basketball is predetermined to be linked to exhibiting three aspects of teamwork. The three aspects of teamwork linked to success in the game and are ‘Working Together,’ ‘Closeness,’ and ‘Team Spirit.’ The rules (374) of the exemplary athletic game (368) of Australian Rules Kangaroo Basketball define the game as a team game (702) wherein no dribbling of the basketball is allowed (704) and players may only advance or move the ball by passing (706) to one another. The rules (374) of the exemplary athletic game (368) of Australian Rules Kangaroo Basketball also reward a point to a player that shoots the ball in a basket (708) and a point for cheering for another player (710).

The exemplary athletic game (368) of Australian Rules Kangaroo Basketball includes a theme (376) of ‘Australia.’ Themed games advantageously provide additional enjoyment to the children, help the children remember the rules of the game, and help to make apparent to the children the aspects of the targeted life skill defined by the curriculum.

As mentioned above, the exemplary athletic game (368) Australian Rules Kangaroo Basketball includes rules (374) designed such that success in playing the game is predetermined to be linked to exhibiting three aspects of teamwork. The three aspects of teamwork supported by the rules include a primary aspect (378) ‘Working Together.’ Demonstrating a primary aspect (378) of the targeted life skill (370) is predetermined to provide more success in playing the athletic game than other a secondary aspects or tertiary aspects. The aspect (378) of ‘Working Together’ has associated physical activities (380) that exhibit the aspect. The physical activities (380) of ‘Passing’ and playing ‘Defense’ are exhibit the aspect of ‘Working Together.’

The three aspects of teamwork supported by the rules of Australian Rules Kangaroo Basketball include a secondary aspect (382) ‘Closeness.’ Demonstrating the secondary aspect (382) of the targeted life skill (370) is typically predetermined to provide success in playing the athletic game but less success than the primary aspect. The secondary aspect (382) of ‘Closeness’ has associated physical activities (384) that exhibit the secondary aspect. The physical activities (384) of ‘Helping Teammates Play Well’ exhibit the secondary aspect of ‘Closeness.’

The three aspects of teamwork supported by the rules of Australian Rules Kangaroo Basketball also include a tertiary aspect (386) ‘Team Spirit.’ Demonstrating the tertiary aspect (386) of the targeted life skill (370) is typically predetermined to provide success in playing the athletic game but less success than the primary aspect and the secondary aspect. The tertiary aspect (386) of ‘Team Spirit’ has associated physical activities (388) that exhibit the tertiary aspect. The physical activities (388) of ‘Cheering for Teammates’ is defined to exhibit the tertiary aspect of ‘Team Spirit.’

The three aspects of teamwork of Australian Rules Kangaroo Basketball are three aspects of team work that are included in a plurality of aspects of teamwork defined by a teamwork life skill curriculum (360). The exemplary teamwork life skill curriculum (360) of FIG. 3 includes hard work (352), working together (354), leadership (356), reliability (358), closeness (360), enthusiasm (362), emotional control (364), awareness (333), no fear of failure (712), determination (714), talent (716), train the brain (718), team spirit (720), preparedness (724), and be you (728).

As discussed above, curriculums for life skill education according to the present invention include of have associated with them a set of athletic games. The example of Australian Rules Kangaroo Basketball of FIG. 3 illustrates only one of a set athletic games that together teach all of the aspects (352, 354, 356, 358, 360, 362, 364, 333, 712, 714, 716, 718, 720, 724, 725, 728) of teamwork defined by the curriculum.

As with the athletic games themselves, curriculums according to the present invention may be themed programs. Such themed programs may provide increased interest and therefore education in the life skill for the children.

The exemplary game (368) of Australian Rules kangaroo Basketball of FIG. 3 includes a game type (373) of ‘ball game’. A game type is a category of game. Examples of game types include ball games, relays such, circle games, games that use parachutes and others as will occur to those of skill in the art. Game types are useful in defining a set of games for a curriculum for children of different types. For example, older children may require more diversity in games to hold their interest and therefore, some curriculums include or have associated with them a plurality of games wherein the plurality of games that comprise a collection of games of all types.

Alternatively, for example, younger children may need more consistency and repetition and therefore, some curriculums include or have associated with them a plurality of games that comprise a collection of games of a single type.

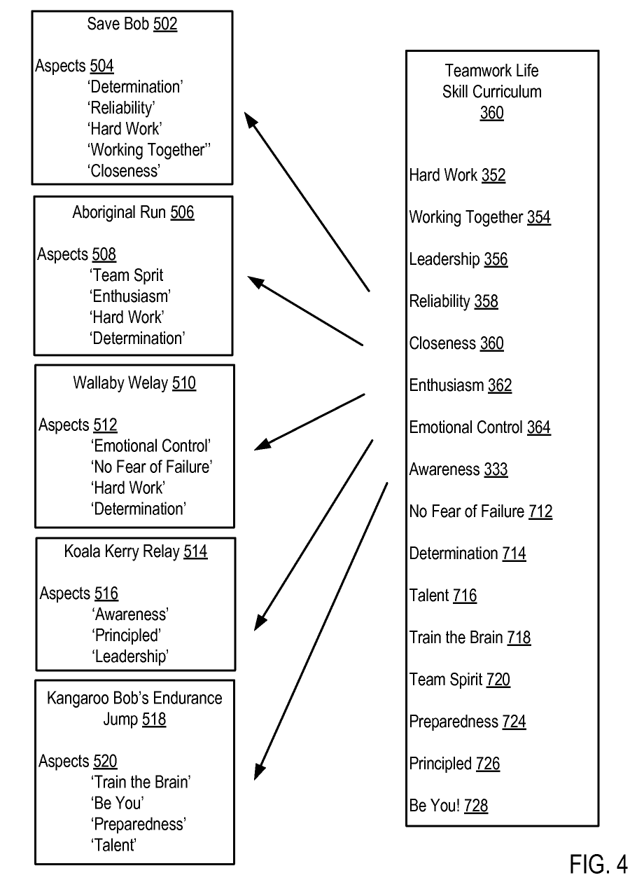

As discussed above, often athletic games are associated with curriculums according to the present invention. As such, often a collection of games may together teach each of the aspects of the curriculum. For further explanation, therefore, FIG. 4 sets forth a block diagram of five themed athletic games that together teach each aspect of a teamwork life skill curriculum. In the example of FIG. 4, the athletic game ‘Save Bob’ (502) teaches the aspects (504) of teamwork defined in the curriculum (360) of ‘determination’ (714), ‘reliability’ (358), ‘hard work’ (352), ‘working together’ (354), and closeness ‘(360). The game Save Bob teaches these aspects through the physical activities of children pulling a rope to rescue kangaroo stuffed animal.

In the example of FIG. 4, the athletic game ‘Aboriginal Run’ (506) teaches the aspects (508) of teamwork defined in the curriculum (360) of ‘team spirit’ (720), ‘enthusiasm’ (362), ‘hard work’ (352), and ‘determination’ (714). The game Aboriginal Run teaches these aspects through the physical activities of a themed endurance relay race.

In the example of FIG. 4, the athletic game ‘Wallaby Welay’ (510) teaches the aspects (512) of teamwork defined in the curriculum (360) of ‘emotional control’ (364), ‘no fear of failure’ (712), ‘hard work’ (352), and ‘determination’ (714). The game Wallaby Welay teaches these aspects through the physical activities of a themed relay race using potato sacks.

In the example of FIG. 4, the athletic game ‘Koala Kerry Relay’ (514) teaches the aspects (516) of teamwork defined in the curriculum (360) of ‘awareness’ (333, ‘principled’ (726), and ‘leadership’ (356). The game Koala Kerry Relay’ teaches these aspects through the physical activities of another themed relay race.

In the example of FIG. 4, the athletic game ‘Kangaroo Bob's Endurance Jump’ (518) teaches the aspects (520) of teamwork defined in the curriculum (360) of ‘train the brain’ (718), ‘be you’ (728), ‘preparedness’ (724), and ‘talent’ (716). The game Kangaroo Bob‘s Endurance Jump teaches these aspects through the physical activities of a themed collective endurance jump.

As discussed above, for curriculum-based life skill education for soft contained play centers according to the present invention include observing a child play the associated set of athletic games in a soft contained play center. For further explanation, therefore, FIG. 5 sets forth a flow chart illustrating an exemplary method of observing a child play a series of athletic games in a soft contained play center. The method of FIG. 5 includes selecting (404) one (406) of the associated set (201) of athletic games (202). Such athletic games are designed to be played in designated areas in the soft contained play center or on one or more inflatable play areas in the soft contained play center. The selected athletic games are also designed with specific physical activities demonstrating one or more individual aspects of the life skill defined by the curriculum associated with the game. The rules of the selected athletic game are typically designed such that success in playing the selected athletic game (206) is predetermined to be linked to exhibiting one or more predefined aspects of the particular life skill by exhibiting the physical activities demonstrating those predefined aspects.

Often athletic games selected according to the method of FIG. 5 are themed athletic games targeted at a particular life skill and targeted for children of a particular ages and skill levels. In the example of FIG. 5, selecting (404) one (406) of the associated set (201) of athletic games (202) is carried out in dependence upon game selection criteria (402) for the curriculum. Game selection criteria (402) are factors for determining which athletic game to select for teaching the targeted life skill and when to select the athletic game. Examples of game selection criteria include the number of children to play the game, the ages of the children to play the game, a game history including which games have been played and when the games are played, the competence of the instructors available to administer the game, the type of game played during a game selection time period and others as will occur to those of skill in the art.

To keep children interested in playing the athletic games and therefore in learning the targeted life skill, selecting (404) one (406) of the associated set (201) of athletic games (202) according to the present invention may include periodically selecting an athletic game at predetermined incremental time periods. The incremental time period, such as for example, every 15 minutes, is typically designed to facilitate the interest of the child in the game and also provide repetition for learning the life skill.

The method of FIG. 5 also includes explaining (408) to one or more children (410) the rules of the selected athletic game (406). Explaining (408) to one or more children (410) the rules of the selected athletic game (406) according to the method of FIG. 5 may be carried out by telling a predetermined story designed to explain the rules of the game. Telling a predetermined story designed to explain the rules of the game advantageously holds the attention of children thereby increasing the ability of the children to learn the rules of the game.

The method of FIG. 5 also includes explaining (412) to the one or more children (410) the one or more predefined aspects of the life skill linked to success in playing the selected athletic game (406). Explaining (412) to the one or more children (410) the one or more predefined aspects of the life skill linked to success in playing the selected athletic game (406) may be carried out by telling a predetermined story designed to explain the one or more aspects of the targeted life skill defined by the curriculum. Telling a predetermined story designed to explain the one or more predefined aspects of the targeted life skill defined by the curriculum advantageously holds the attention of children thereby increasing the ability of the children to learn the predefined aspects of the targeted life skill.

The method of FIG. 5 also includes administering (414) the playing of the selected athletic game (406) by the one or more children (410) in the soft contained play center (218). In the method of FIG. 5, administering (414) the playing of the selected athletic game (406) by the one or more children (410) in the soft contained play center (218) is carried out by an instructor (212) of the soft contained play center. Administering the playing of the selected athletic game in a soft contained play center may be carried out by supervising the playing of the game in a designated game area in a soft contained play center or supervising the playing of the game on inflatable play areas in a soft contained play center.

Some athletic games useful in teaching children a targeted life skill in a soft contained play center according to the present invention may be team games having more than one team. In such cases, administering (414) the playing of the selected athletic game (406) by the one or more children (410) in the soft contained play center (218) typically includes assigning the children to one or more teams. Assigning the children to one or more teams may be carried out by assigning children to one or more teams in dependence upon a number of factors such as the age of the children, the type of selected game, the physical attributes of the individual children, the accomplishments with regard to a curriculum of the individual children, and many more as will occur to those of skill in the art.

Children often learn through repetition. Administering (414) the playing of the selected athletic game (406) by the one or more children (410) in the soft contained play center (218) may also include playing the game for a predetermined number of times. Playing a set of the game, that is, playing the game for a predetermined number of times advantageously reinforces the aspects of the life skill taught through the playing of the game.

The method of FIG. 5 also includes rewarding (418) each child (214) for each aspect exhibited by the child while playing the selected athletic game (406). Predefined aspects of the particular life skill are exhibited by performing one or more defined physical activities in the selected athletic game that demonstrate the aspects of the life skill. For example, in a ball game for teaching teamwork, the physical activity of passing a ball may demonstrate the aspect of working together.

One way of rewarding (418) each child (214) for each aspect exhibited by the child while playing the selected athletic game (406) may be carried out by providing the child with an award redeemable for a prize. Redeemable awards may often be combined with other redeemable awards for a prize. Such a redeemable award may be implemented through one or more tickets that may be redeemed for a prize made available by the soft contained play center. Prizes of higher value are typically available for more tickets than prizes of lower value. The use of redeemable awards provides a vehicle for rewarding the child with a prize that the child finds most satisfying thereby increasing the reinforcement of the life shill taught through the method of FIG. 5.

Observing a child play a series of athletic games in a soft contained play center according to the method of FIG. 5 may also include providing to caregivers an explanation of the correlation between the aspects of the life skill and the life skill. A caregiver is the caretaker of a child. Caregivers include parents, grandparents, relatives, friends, nannies, baby-sitters, and any other caretaker of a child that will occur to those of skill in the art. Providing to a caregiver an explanation of the correlation between the aspects of the life skill and the life skill advantageously provides to the caregiver evidence that the cost and time spent at the soft contained play center is well spent.

Observing a child play a series of athletic games in a soft contained play center according to the method of FIG. 5 may also providing to a caregiver an explanation of the correlation between the child's exhibition of the aspects of the life skill and the award. Providing to a caregiver an explanation of the correlation between the child's exhibition of the aspects of the life skill and the award advantageously provides to the caregiver evidence that the cost and time spent at the soft contained play center is well spent.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for curriculum-based life skill education for soft contained play centers, the method comprising:
providing a curriculum defining a plurality of predefined aspects of a life skill and having an associated set of athletic games, wherein success in playing each athletic game is predetermined to be linked to exhibiting one or more aspects of the particular life skill defined by the curriculum;
observing a child play the associated set of athletic games in a soft contained play center; and
providing a completion award for exhibiting all the aspects of the particular life skill defined by the curriculum while playing the set of athletic games associated with the curriculum.

2. The method of claim 1 wherein the life skill comprises teamwork.

3. The method of claim 1 wherein the set of athletic games associated with the curriculum further comprise a plurality of themed games having one or more components of the theme, each component of the theme based upon one or more of predefined aspects of the life skill defined by the curriculum.

4. The method of claim 1 wherein the set of athletic games associated with the curriculum are designed to be played on one ore more inflatable play areas in the soft contained play center.

5. The method of claim 1 wherein success in playing each of the set of athletic games associated with the curriculum is predetermined to be linked to a primary aspect of the life skill and linked to one or more secondary aspects of the life skill.

6. The method of claim 1 wherein providing a completion award for receiving an accomplishment award for each aspect of the life skill further comprises providing a redeemable award for redeeming a prize.

7. The method of claim 1 wherein providing a curriculum defining a plurality of predefined aspects of a life skill and having an associated set of athletic games further comprises providing a themed program identifying each aspect of the particular life skill in the curriculum and an explanation of the relationship between each aspect of the life skill and the life skill itself.

8. The method of claim 1 wherein observing a child play a series of athletic games in a soft contained play center further comprises:
selecting one of the associated set of athletic games;
explaining to one or more children the rules of the selected athletic game;
explaining to the one or more children the one or more predefined aspects of the life skill linked to success in playing the selected athletic game;
administering the playing of the selected athletic game by the one or more children in the soft contained play center.

9. The method of claim 8 further comprising rewarding each child for each aspect exhibited by the child while playing the selected athletic game.

10. The method of claim 8 wherein selecting one of the associated set of athletic games further comprises periodically selecting an athletic game in dependence at incremental time periods.

11. The method of claim 8 wherein explaining to one or more children the rules of the selected athletic game further comprises telling a predetermined story designed to explain the rules of the game.

12. The method of claim 8 wherein explaining to the one or more children the one or more predefined aspects of the life skill linked to success in playing the selected athletic game further comprises telling a predetermined story designed to explain the one or more aspects of the targeted life skill defined by the curriculum.

13. The method of claim 8 wherein administering the playing of the selected athletic game by the children in a soft contained play center further comprises assigning the children to one or more teams.

14. The method of claim 8 wherein administering the playing of the selected athletic game by the children in a soft contained play center further comprises repeating for a predetermined number of times the playing of the athletic game.

15. The method of claim 8 further comprising providing to caregivers an explanation of the correlation between the aspects of the life skill and the life skill.

16. A life skill curriculum for soft contained play centers, the curriculum comprising:
an identified life skill defining the subject of the curriculum;
an identified plurality of aspects of the life skill defined by the curriculum; and
a plurality of games designed to be played in a soft contained play center, wherein success in playing each athletic game is predetermined to be linked to exhibiting one or more predefined aspects of the particular life skill, and wherein the plurality of games together are predetermined to be linked to exhibiting all of the aspects of the life skill.

17. The life skill curriculum of claim 16 wherein each of the plurality of games has a game type, and wherein the plurality of games comprises at least one game of each type and the plurality of games comprises a collection of games of all types.

18. The life skill curriculum of claim 16 wherein each of the plurality of games has a game type, and wherein the plurality of games comprises a collection of games of a single type.

19. A soft contained play center, the soft contained play center comprising:
one or more inflatable play areas; and
a award redemption facility;
the soft contained play center configured for curriculum-based life skill education including:
providing a curriculum defining a plurality of predefined aspects of a life skill and having an associated set of athletic games, wherein success in playing each athletic game is predetermined to be linked to exhibiting one or more aspects of the particular life skill defined by the curriculum;
observing a child play the associated set of athletic games in a soft contained play center; and
providing a completion award for exhibiting all the aspects of the particular life skill defined by the curriculum while playing the set of athletic games associated with the curriculum.
